(19) United States
(12) Patent Application Publication
(10) Pub. No.: US 2017/0221180 A1
(43) Pub. Date: Aug. 3, 2017

(54) METHOD AND SYSTEM FOR PROVIDING A VIRTUAL REALITY SPACE

(71) Applicant: COLOPL, Inc., Tokyo (JP)

(72) Inventor: Kento NAKASHIMA, Tokyo (JP)

(21) Appl. No.: 15/385,720

(22) Filed: Dec. 20, 2016

(30) Foreign Application Priority Data
Jan. 29, 2016 (JP) 2016-15384

(51) Int. Cl. G06T 3/20; G06T 19/00; G06F 3/01

(52) U.S. Cl. CPC G06T 3/20; G06F 3/013; G06T 19/006; G06T 19/00

(57) ABSTRACT

To present a three-dimensional virtual reality space image having various visual effects to a user, provided is a method of providing a virtual reality space to which a user is immersed with use of a head-mounted display. The method includes defining the virtual reality space. The method further includes specifying a reference line of sight from a point of view in the virtual reality space based on movement of the user wearing the head-mounted display. The method further includes specifying a field-of-view region from the point of view based on the reference line of sight. The method further includes moving a virtual display in the virtual reality space to a position in the field-of-view region. The method further includes generating a field-of-view image corresponding to the field-of-view region to display the field-of-view image on the head-mounted display.

### RELATED APPLICATIONS

The present application claims priority to Japanese Application Number 2016-015384, filed Jan. 29, 2016, the disclosure of which is hereby incorporated by reference herein in its entirety.

### BACKGROUND

This disclosure relates to a method and system for providing a virtual reality space.

In WO 2014/156389 A1, there is disclosed a technology of displaying, on a content image of a virtual space displayed to a user wearing a head-mounted display (hereinafter also referred to as “HMD”), a user's outside world image in a real space in a superimposed manner.

In the technology of WO 2014/156389 A1, the outside image is merely superimposed on the content image to be displayed on the HMD so that the user who is wearing the HMD and thus cannot visually recognize the outside environment may be notified of his/her situation.

### SUMMARY

At least one embodiment of this disclosure has been made in view of the above-mentioned point. That is, a virtual display for picture-in-picture display, which is capable of outputting a predetermined content, is arranged in a three-dimensional virtual reality space (hereinafter also simply referred to as “three-dimensional virtual space”, “virtual space”, and “virtual reality space”) so that the operation of the virtual display may be dynamically controllable. That is, at least one embodiment of this disclosure has an object to present a three-dimensional virtual reality space image having various visual effects to the user.

In order to help solve the above-mentioned problem, according to at least one embodiment of this disclosure, there is provided a method of providing a virtual reality space to which a user is immersed with use of a head-mounted display. The method includes defining the virtual reality space. The method further includes specifying a reference line of sight from a point of view in the virtual reality space based on movement of the user wearing the head-mounted display. The method further includes specifying a field-of-view region from the point of view based on the reference line of sight. The method further includes moving a virtual display in the virtual reality space to a position in the field-of-view region. The method further includes generating a field-of-view image corresponding to the field-of-view region to display the field-of-view image on the head-mounted display.

Further, according to at least one embodiment of this disclosure, there is provided a system for providing a virtual reality space to which a user is immersed with use of a head-mounted display. The system includes a computer coupled to the head-mounted display. The system includes means for defining the virtual reality space. The system further includes means for specifying a reference line of sight from a point of view in the virtual reality space based on movement of the user wearing the head-mounted display; means for specifying a field-of-view region from the point of view based on the reference line of sight. The system further includes means for moving a virtual display in the virtual reality space to a position in the field-of-view region. The system further includes means for generating a field-of-view image corresponding to the field-of-view region to display the field-of-view image on the head-mounted display.

According to this disclosure, the arrangement of the virtual display is dynamically controlled in a visual region in the three-dimensional virtual reality space so that the content image on the virtual display can be displayed in a picture-in-picture format with various visual effects.

### BRIEF DESCRIPTION OF THE DRAWINGS

FIG. 1 is a schematic view for illustrating an HMD system according to at least one embodiment of this disclosure.

FIG. 2 is a functional block diagram of a control circuit unit according to at least one embodiment of this disclosure.

FIG. 3 is an XYZ space view of an example of a three-dimensional virtual space according to at least one embodiment of this disclosure.

FIG. 4A and FIG. 4B are respectively a side view and a plan view corresponding to the XYZ space view illustrated in FIG. 3.

FIG. 5 is a flow chart of an operation example of the control circuit unit according to at least one embodiment of this disclosure.

FIG. 6 is a schematic view of an operation example of a control circuit unit according to at least one embodiment of this disclosure.

FIG. 7 is a schematic view of an operation example of a control circuit unit according to at least one embodiment of this disclosure.

### DETAILED DESCRIPTION

First, embodiments of this disclosure are described by enumerating contents thereof. A method and SYSTEM for providing a virtual reality space according to one embodiment of this disclosure have the following configurations.

(Item 1) A method of providing a virtual reality space to which a user is immersed with use of a head-mounted display. The method includes defining the virtual reality space. The method further includes specifying a reference line of sight from a point of view in the virtual reality space based on movement of the user wearing the head-mounted display. The method further includes specifying a field-of-view region from the point of view based on the reference line of sight. The method further includes moving a virtual display in the virtual reality space to a position in the field-of-view region. The method further includes generating a field-of-view image corresponding to the field-of-view region to display the field-of-view image on the head-mounted display.

(Item 2) A method according to Item 1, in which the moving of the virtual display is repeatedly performed in synchronization with displacement of the reference line of sight along with the movement of the user wearing the head-mounted display.

(Item 3) A method according to Item 1, further including determining whether or not a superimposition ratio of the virtual display to the field-of-view region is a predetermined value or less. The moving of the virtual display is performed when the superimposition ratio is determined to be the predetermined value or less.

(Item 4) A method according to any one of Items 1 to 3, in which the moving of the virtual display includes moving the virtual display along a spherical surface having a first radius.

(Item 5) A method according to Item 4, in which the defining of the virtual reality space includes defining the virtual reality space such that a 360-degree content is displayed on the spherical surface having the first radius.

(Item 6) A method according to Item 4, in which the defining of the virtual reality space includes defining the virtual reality space such that a 360-degree content is displayed on the spherical surface having a second radius different from the first radius.

(Item 7) A method according to any one of Items 1 to 6, in which, in the moving of the virtual display, the position in the field-of-view region is a position having a predetermined polar angle and/or a predetermined azimuth from the reference line of sight.

(Item 8) A method according to any one of Items 1 to 7, in which the defining of the virtual reality space includes defining the virtual reality space such that a target object is arranged. The moving of the virtual display further includes specifying the target object in the virtual reality space. The virtual display is further moved to a position in the field-of-view region in a direction toward the target object from the reference line of sight at the point of view.

(Item 9) A method according to any one of Items 1 to 8, in which the moving of the virtual display is performed in response to a predetermined user action.

(Item 10) A system for providing a virtual reality space to which a user is immersed with use of a head-mounted display. The system includes a computer coupled to the head-mounted display. The system includes means for defining the virtual reality space in which a virtual display is to be arranged. The system further includes means for specifying a reference line of sight from a point of view in the virtual reality space based on movement of the user wearing the head-mounted display. The system further includes means for specifying a field-of-view region from the point of view based on the reference line of sight. The system further includes means for moving the virtual display in the virtual reality space to a position in the field-of-view region. The system further includes means for generating a field-of-view image corresponding to the field-of-view region to display the field-of-view image on the head-mounted display.

(Item 11) A system according to Item 10, in which the virtual display is moved in synchronization with displacement of the reference line of sight along with the movement of the user wearing the head-mounted display.

(Item 13) A system according to Item 10, further including means for determining whether or not a superimposition ratio of the virtual display to the field-of-view region is a predetermined value or less. The virtual display is moved when the superimposition ratio is determined to be the predetermined value or less.

Specific examples of a method and system for providing a virtual reality space according to at least one embodiment of this disclosure are described below with reference to the drawings. This disclosure is not limited to those examples, and is defined by the appended claims. One of ordinary skill in the art would understand that this disclosure includes all modifications within the appended claims and the equivalents thereof. In the following description, like elements are denoted by like reference symbols in the description of the drawings, and redundant description thereof is omitted.

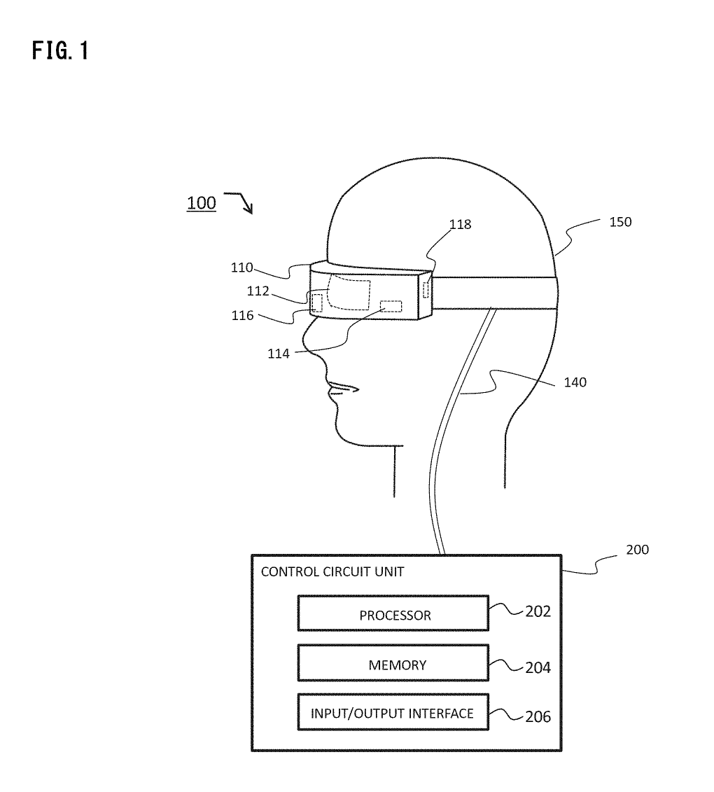

FIG. 1 is an exemplary hardware configuration view of an HMD system 100 according to at least one embodiment of this disclosure. The HMD system 100 includes an HMD 110 and a control circuit unit 200. The HMD 110 and the control circuit unit 200 are, as an example, electrically connected to each other by a cable 140 so as to enable mutual communication. Instead of the cable 140, wireless connection may be used. The HMD 110 is a display device to be used by being worn on a head of a user 150. The HMD 110 includes a display 112, a sensor 114, an eye tracking device (hereinafter referred to as “ETD”) 116, and speakers (headphones) 118. In at least one embodiment, any one of the ETD 116 or the sensor 114 is omitted from HMD system 100.

The display 112 is configured to present an image in a field of view of the user 150 wearing the HMD 110. For example, the display 112 may be configured as a non-transmissive display or a partially transmissive display. The sight of the outside world of the HMD 110 is blocked (or partially blocked) from the field of view of the user 150, and the user 150 can see only the image displayed on the display 112. On the display 112, for example, a field-of-view image generated with use of computer graphics is displayed. As an example of the image generated with use of computer graphics, there is given a virtual space image obtained by forming an image of a virtual reality space (for example, a world created in a computer game). In this manner, the user wearing the HMD is immersed to the three-dimensional virtual reality space.

The display 112 may include a right-eye sub-display configured to provide a right-eye image, and a left-eye sub-display configured to provide a left-eye image. Two two-dimensional images for the right eye and the left eye are superimposed on the display 112, and thus a three-dimensional virtual space image having a three-dimensional feel is provided to the user 150. Further, as long as the right-eye image and the left-eye image can be provided, the display 112 may be constructed of one display device. For example, a shutter configured to enable recognition of a display image with only one eye may be switched at high speed, to thereby independently provide the right-eye image and the left-eye image.

The ETD 116 is configured to track the movement of the eyeballs of the user 150, to thereby detect the direction of the line of sight of the user 150. For example, the ETD 116 includes an infrared light source and an infrared camera. The infrared light source is configured to irradiate the eye of the user 150 wearing the HMD 110 with infrared rays. The infrared camera is configured to take an image of the eye of the user 150 irradiated with the infrared rays. The infrared rays are reflected on the surface of the eye of the user 150, but the reflectance of the infrared rays differs between the pupil and a part other than the pupil. In the image of the eye of the user 150 taken by the infrared camera, the difference in reflectance of the infrared rays appears as the contrast of the image. Based on this contrast, the pupil is identified in the image of the eye of the user 150, and further, the direction of the line of sight of the user 150 is detected based on the position of the identified pupil.

The sensor 114 is a sensor configured to detect the inclination and/or the position of the HMD 110 worn on the head of the user 150. For example, a magnetic sensor, an angular velocity sensor, an acceleration sensor, or a combination thereof is preferred to be used as the sensor 114. When the sensor 114 is a magnetic sensor, an angular velocity sensor, or an acceleration sensor, the sensor 114 is built into the HMD 110, and is configured to output a value (magnetic, angular velocity, or acceleration value) based on the inclination or the position of the HMD 110. By processing the value output from the sensor 114 by an appropriate method, the inclination and the position of the HMD 110 worn on the head of the user 150 are calculated. The inclination and the position of the HMD 110 can be used to change a display image of the display 112 so as to follow the movement of the head of the user 150 when the head is moved. For example, when the user 150 turns his/her head to the right (or left, upward, or downward), the display 112 may display a virtual sight in the right (or left, upward, or downward) of the user in the virtual reality space. With this, the user 150 can experience a higher sense of immersion to the virtual reality space. In at least one embodiment, a sensor provided outside of the HMD 110 may be employed as sensor 114. For example, the sensor 114 may be an infrared sensor separated from the HMD 110 and installed at a fixed position in a room. An infrared emitting member or an infrared reflecting marker formed on the surface of the HMD 110 is detected with use of the infrared sensor. Such a type of sensor 114 is sometimes called a position tracking sensor.

The speakers (headphones) 118 are respectively provided near the right and left ears of the user 150 wearing the HMD 110. The speakers 118 are configured to convert electrical sound signals generated by the control circuit unit 200 into physical vibrations, to thereby provide sounds to the right and left ears of the user. A time difference and a volume difference may be set to the sounds output from the right and left speakers so that the user 150 can sense the direction and the distance of a sound source arranged in the virtual space.

The control circuit unit 200 is a computer to be connected to the HMD 110. The control circuit unit 200 may be mounted on the HMD 110, or may be constructed of other hardware (for example, a specifically-designed personal computer or server computer via a network). Further, a part of the functions of the control circuit unit 200 may be mounted on the HMD 110, and the remaining functions may be mounted on other hardware. As illustrated in FIG. 1, the control circuit unit 200 includes a processor 202, a memory 204, and an input/output interface 206. The control circuit unit 200 may further include a communication interface 208 (not shown).

The processor 202 is configured to read out a program stored in the memory 204, to thereby execute processing in accordance with the program. When the processor 202 executes an information processing program stored in the memory 204, various functions of the control circuit unit 200 (described later) to be described later are achieved as software. The processor 202 includes a central processing unit (CPU) and a graphics processing unit (GPU). The memory 204 has stored therein at least an operating system and the information processing program. The operating system is a computer program for controlling at least a portion of operation of the control circuit unit 200. The information processing program is a computer program for implementing respective functions of the control circuit unit 200. The memory 204 can further temporarily or permanently store data generated by the operation of the control circuit unit 200. Specific examples of the memory 204 include a read only memory (ROM), a random access memory (RAM), a hard disk, a flash memory, and an optical disc.

The input/output interface 206 is configured to receive inputs for causing the image generating device 200 to function from the user 150 of the HMD system 100. Specific examples of the input/output interface 206 include a game controller, a touch pad, a mouse, and a keyboard. The communication interface 208 (not shown) includes various wire connection terminals for communicating to/from an external device via a network, and various processing circuits for wireless connection. The communication interface 208 is configured to adapt to various communication standards or protocols for receiving an external camera content, a web content, and a digital broadcasting content via a local area network (LAN) or the Internet.

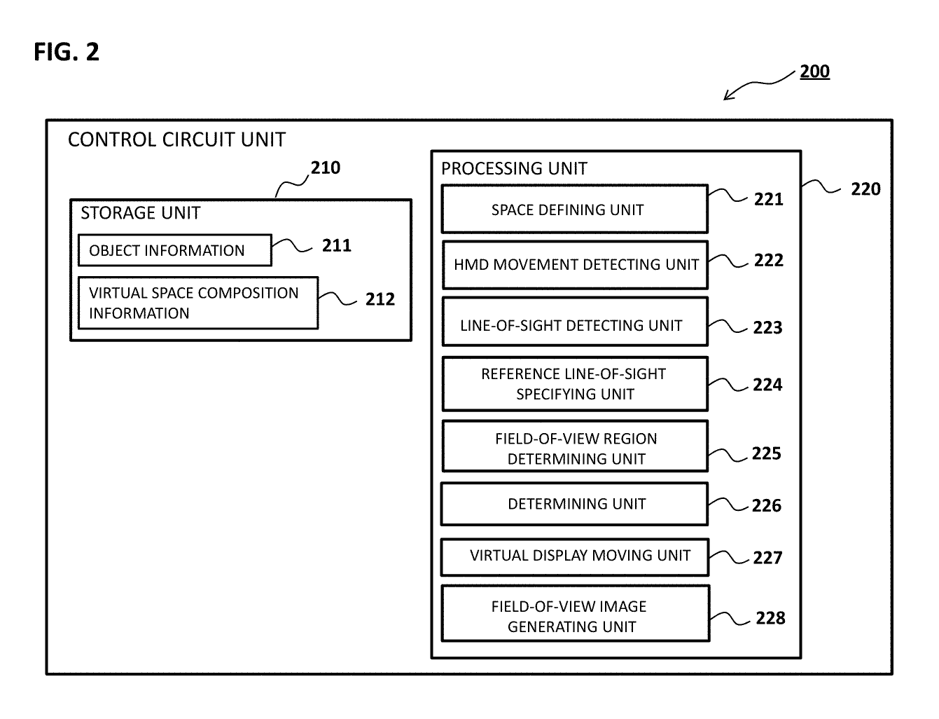

FIG. 2 is an exemplary block diagram for illustrating a functional configuration to be implemented to the control circuit unit 200. The control circuit unit 200 includes a storage unit 210 and a processing unit 220. Further, the storage unit 210 includes object information 211 and virtual space composition information 212. In at least one embodiment, the storage unit 210 corresponds to the memory 204 illustrated in FIG. 1. Further, the processing unit 220 includes a space defining unit 221, an HMD movement detecting unit 222, a line-of-sight detecting unit 223, a reference line-of-sight specifying unit 224, a field-of-view region determining unit 225, a determining unit 226, a virtual display moving unit 227, and a field-of-view image generating unit 228. In at least one embodiment, the respective units 221 to 228 included in the processing unit 220 are able to be implemented using software. That is, the processor 202 illustrated in FIG. 1 may read out and execute each program module in the memory 204, to thereby achieve the functionalities of the respective units 221 to 228.

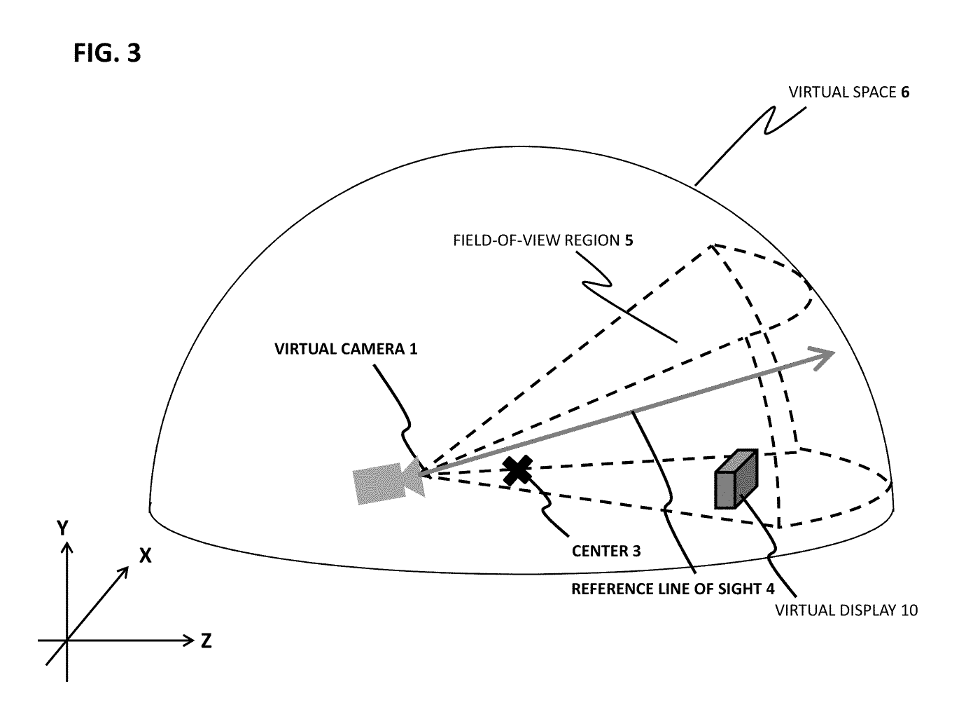

FIG. 3 is an XYZ space view for illustrating an example of the three-dimensional virtual reality space according to at least one embodiment of this disclosure. An XZ plane represents the ground surface, and a Y axis extends in a height direction. A virtual space 6 is formed into, for example, a celestial sphere shape with a center 3 being a center. In the virtual space 6, a virtual camera 1 being a user's point of view and a plurality of computer-controllable objects (for example, a virtual display object 10 and a target object (not shown))) may be arranged. The virtual camera 1 is arranged in the virtual space 6. The virtual camera 1 may always be arranged at the center 3, or may be moved so as to follow the movement of the user 150 (that is, the movement of the head or the movement of the line of sight).

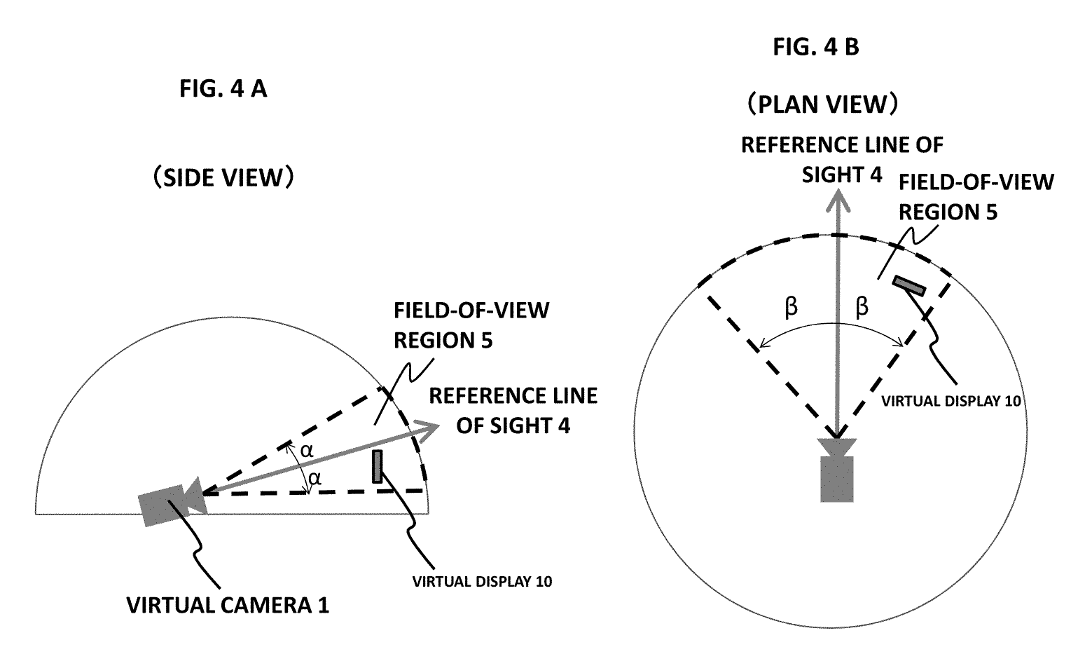

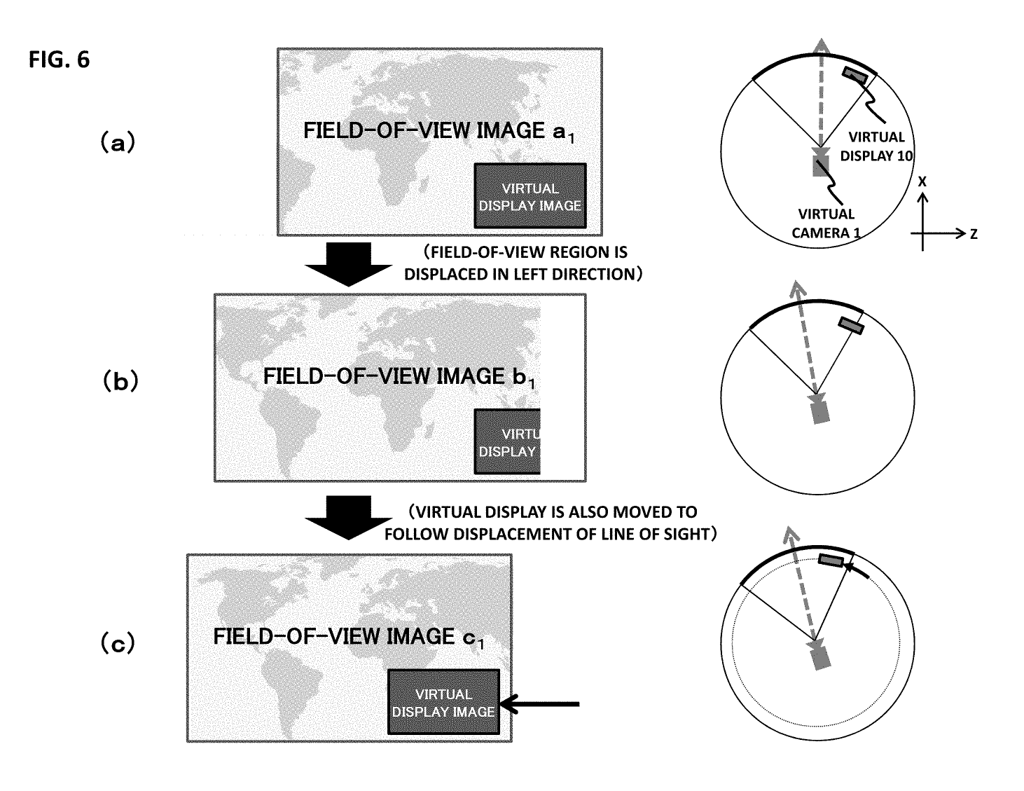

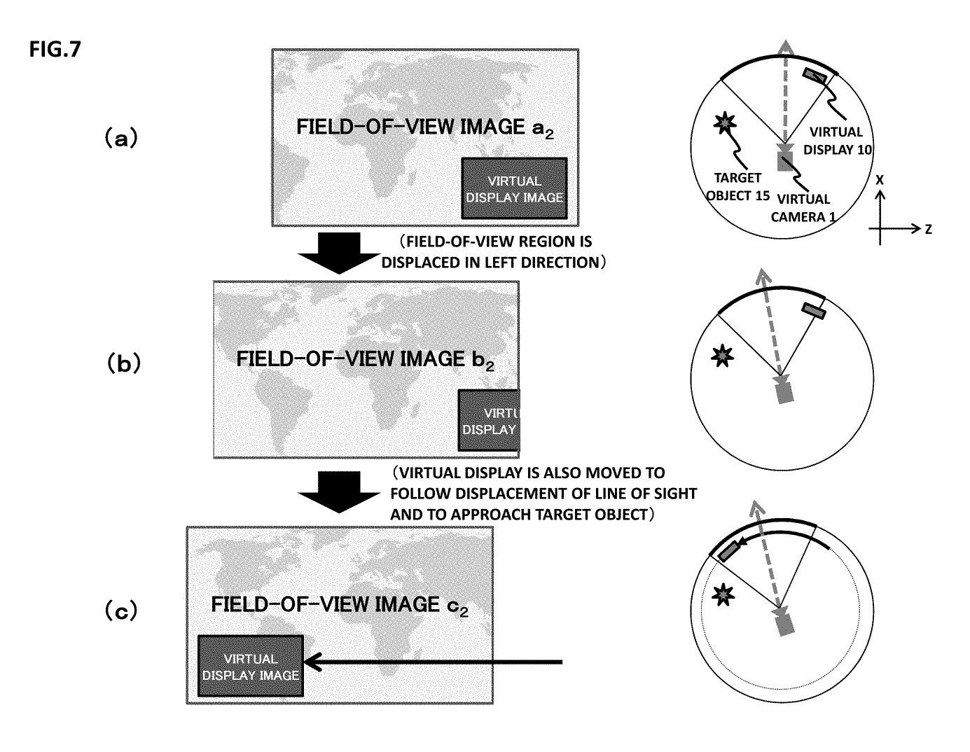

FIG. 4A and FIG. 4B are a side view and a plan view corresponding to the XYZ space view illustrated in FIG. 3, in which the ground surface is viewed from a lateral side and an upper side, respectively. A field-of-view region 5 from the virtual camera 1 (point of view) in the virtual space 6 is determined based on a reference line of sight 4. As illustrated in FIG. 4A and FIG. 4B, the field-of-view region 5 is a three-dimensional space region, and is defined so as to include a range including a predetermined polar angle α and a range including a predetermined azimuth β with the reference line of sight 4 being the center. The field-of-view region 5 is further defined so as to include a part of a celestial sphere surface. A field-of-view image from the virtual camera 1 is generated as an image corresponding to the field-of-view region 5, and the generated image is displayed on the HMD. According to at least one embodiment of this disclosure, the field-of-view image is preferred to be formed such that a 360-degree content is formed as a spherical surface image along the celestial sphere surface. Specifically, in at least one embodiment, the celestial sphere surface is formed into a grid shape, and to paste a part of the 360-degree content to each grid section in association therewith, to thereby form a spherical image as a whole. In the examples of the field-of-view image described later with reference to FIG. 6 and FIG. 7, one of ordinary skill in the art would understand that an image of a world map is pasted as a spherical image along the celestial sphere surface. The 360-degree content may be any digital content including a still-image content, a moving-image content, an audio content, and other contents.

According to at least one embodiment of this disclosure, further, an object (virtual display 10 in FIG. 3, FIG. 4A, and FIG. 4B) is arranged so as to be accommodated in the field-of-view region 5 of the virtual space 6, and the field-of-view image is generated so as to also include an image of the object as viewed from the virtual camera 1. That is, the field-of-view image is generated such that an image of the 360-degree content to be displayed in a part of the celestial sphere surface associated with the field-of-view region 5 is set as a background image, and that the image of the object arranged in the field-of-view region 5 is superimposed thereon. In at least one embodiment, the virtual display 10 arranged in the virtual space 6 is a virtual television or a virtual web browser capable of displaying a television content or a web content in the virtual reality space, and can output a content received from the outside via the communication interface 208 (not shown) of the control circuit unit 200. The content on the virtual display 10 may be, similarly to the 360-degree content, any digital content including a still-image content, a moving-image content, an audio content, and other contents. The virtual display 10 may have an arbitrary shape, and may be arranged at an arbitrary space position. As an example, the virtual display may have a curved shape.

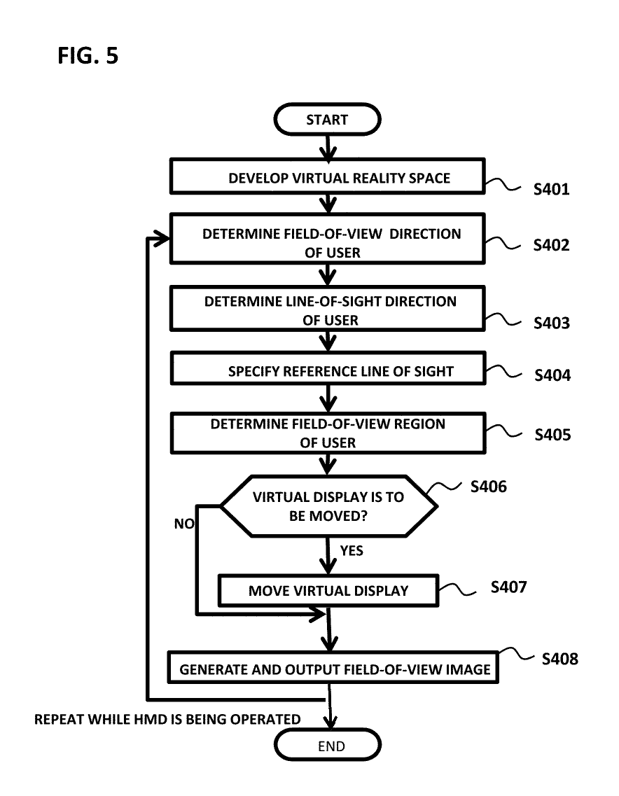

FIG. 5 is an illustration of an operation example of the control circuit unit 200 configured to provide a method of providing the virtual reality space to which the user is immersed with use of the HMD, according to at least one embodiment of this disclosure. FIG. 5 is a flow chart for illustrating information processing of the control circuit unit 200. Each functional block illustrated in FIG. 2 is caused to function to execute each step of the processing.

First, the space defining unit 221 defines the virtual reality space to develop the virtual reality space (S401). More specifically, the space defining unit 221 defines and develops the virtual reality space with use of the object information 211 and the virtual space composition information 212 stored in the storage unit 210. The object information 211 includes arrangement information of the virtual display 10 or the target object (described later) together with accompanying information, e.g., attribute tag information associated with each item of information. The virtual space composition information 212 includes information of the 360-degree content image pasted along the celestial sphere and information of the content to be displayed on the virtual display.

The HMD movement detecting unit 222 determines the field-of-view direction of the user based on the movement of the user 150 wearing the HMD 110 (S402). Further, the line-of-sight detecting unit 223 determines the line-of-sight direction of the user (S403). With this, the reference line-of-sight specifying unit 224 specifies the reference line of sight from the point of view in the virtual reality space (S404). Then, the field-of-view region determining unit 225 determines the field-of-view region 5 from the point of view, which is illustrated in FIG. 3, FIG. 4A, and FIG. 4B, based on the reference line of sight 4 (S405).

More specifically, the HMD movement detecting unit 222 acquires over time data corresponding to the position and/or the inclination of the HMD 110 detected by the sensor 114, to thereby determine the field-of-view direction of the user 150. Next, the line-of-sight detecting unit 223 determines the line-of-sight direction of the user based on the gazing direction (s) of the right eye and/or the left eye of the user, which is/are detected by the ETD 116. In at least one embodiment, the line-of-sight direction is defined as, as an example, an extension direction of a straight line, which passes through a midpoint of the user's right and left eyes and a point of gaze being an intersection of the gazing directions of the right eye and the left eye of the user. Subsequently, the reference line-of-sight specifying unit 224 specifies, as the reference line of sight, for example, a straight line connecting between the midpoint of the right and left eyes of the user 150 and the middle of the display 112 positioned in the field-of-view direction such that the specified reference line of sight corresponds to the reference line of sight 4 in the virtual reality space. The field-of-view region 5 is determined as a three-dimensional region formed so as to include the point of view, the range including the predetermined polar angle α and the range including the predetermined azimuth β with the reference line of sight 4 being the center, and a part of the celestial sphere surface specified based on those ranges (see FIG. 3, FIG. 4A, and FIG. 4B). One of ordinary skill in the art would understand that the determined three-dimensional field-of-view region 5 is changed in synchronization with the displacement of the reference line of sight 4 based on the movement of the user wearing the HMD.

In the processing of Step S406 and the subsequent steps, the operation of the virtual display 10 is dynamically controlled in association with the determined field-of-view region 5. That is, the determining unit 226 determines whether or not to move the virtual display 10 with respect to the field-of-view region 5 (S406). In the case of positive determination (“YES”), the virtual display moving unit 227 moves the virtual display to a predetermined position in the field-of-view region (S407).

More specifically, the determining unit 226 can perform positive determination in response to an arbitrary timing. As an example, in at least one embodiment, the timing is a timing at which the object of the virtual display is deviated from the field-of-view region 5 and thus the user cannot visually recognize the object on the display. As an alternative, the timing may be every time the reference line of sight is displaced in accordance with the movement of the user wearing the HMD. The virtual display moving unit 227 can move the virtual display 10 in a variety of modes in the virtual space 6. As an example, the virtual display moving unit 227 may move the virtual display 10 along a spherical surface having a predetermined radius and having the same center as the celestial sphere surface on which the 360-degree content is displayed. The predetermined radius may be the same radius as the celestial sphere surface of the virtual space 6 or may be a different radius. Further, the position of the movement destination of the virtual display may be any position in the field-of-view region 5.

The “virtual display” is not necessarily limited to a three-dimensional object, and may be any virtual display as long as the virtual display displays a content image in the three-dimensional virtual space 6. For example, regarding a sub-content image directly embedded in the 360-degree content image, the embedded region may be also regarded as the “virtual display”. In this case, the sub-content image is formed as a spherical image having a predetermined size, and is directly pasted to the celestial sphere surface of the virtual space 6. Unlike the case of the 360-degree content image arranged on the celestial sphere surface in a fixed manner, the sub-content image can update its position on the celestial sphere surface. That is, the sub-content image can be formed so as to be movable on the celestial sphere surface so as to enter the field-of-view region 5.

Finally, the field-of-view image generating unit 228 generates the field-of-view image corresponding to the field-of-view region 5, and displays the field-of-view image on the display 112 of the HMD (S408). In at least one embodiment, while the user is wearing the HMD and operating the HMD, Step S402 to Step S408 are repeatedly performed.

Through the execution of the information processing of the flow chart of FIG. 5, there are achieved an operation example of a first embodiment of this disclosure illustrated in FIG. 6, and an operation example of a second embodiment of this disclosure illustrated in FIG. 7. FIG. 6 and FIG. 7 are each an illustration of a set of the field-of-view image to be displayed to the user and an XZ plane view of the virtual space when the field-of-view region is changed from the state of part (a) to the state of part (c). In each of the embodiments of FIG. 6 and FIG. 7, an image of a world map is pasted along the celestial sphere, and a different map part is displayed based on the movement of the user wearing the HMD. Further, in each of the embodiments of FIG. 6 and FIG. 7, the position of the virtual camera 1 is arranged at the center of the celestial sphere, and the virtual display 10 is caused to follow the transition of the field-of-view region from part (a) to part (c) along a concentric spherical surface on the inner side of the celestial sphere. One of ordinary skill in the art would understand that, although the field-of-view region is transitioned in the left direction from part (a) to part (c), the field-of-view region may be transitioned in any direction based on the movement of the user.

In the at least one embodiment in FIG. 6, in part (a), a field-of-view image a₁ is displayed such that the virtual display image is superimposed thereon at the lower right. When the field-of-view region is displaced in the left direction in accordance with the movement of the user wearing the HMD, as illustrated in part (b) of FIG. 6, a field-of-view image b₁ is displayed. The arrangement position of the virtual display 10 is not changed, and hence only a part of the virtual display image is superimposed on the field-of-view image b₁. The timing at which the superimposition ratio of the virtual display to the field-of-view region becomes a predetermined value or less (for example, 50% or less), or the timing at which such an event that the user gives a user action via the input/output interface 206 occurs is detected. That is, the determining unit 226 determines that the virtual display 10 is required to be moved (S406 of FIG. 5). As a result, as illustrated in part (c) of FIG. 6, the virtual display follows the field-of-view region (solid-line arrow), and a field-of-view image c₁ is displayed such that the virtual display image is superimposed at the lower right again. The “lower right” position at which the virtual display image is superimposed can be defined as a predetermined position relative to the field-of-view region 5. Specifically, the position is preferred to be defined as a position having a predetermined polar angle and/or a predetermined azimuth from the reference line of sight in the field-of-view region 5.

As described above, according to at least one embodiment, the virtual display 10 can be dynamically moved in synchronization with the change of the field-of-view region. The virtual display image is not merely superimposed on the field-of-view image at a fixed position, but the virtual display 10 can be displayed in the field-of-view region in various moving modes, and thus various picture-in-picture display modes can be achieved. Specifically, moving modes such as a “following” type illustrated in FIG. 6, and an “appearing” type in which the virtual display appears in the field of view out of nothing may be achieved. As a result, a field-of-view image having various visual effects can be presented to the user.

The at least one embodiment in FIG. 7 differs from the at least one embodiment in FIG. 6 in that a target object 15 is arranged in the virtual space, and that the virtual display 10 is determined to be arranged at a position associated with the arrangement of the target object 15. Field-of-view images a₂ and b₂ of part (a) and part (b) of FIG. 7 are similar to the field-of-view images a₁ and b₁ of FIG. 6, respectively. A field-of-view image c₂ of part (c) of FIG. 7 differs from the field-of-view image c₁ of FIG. 6. In part (b) of FIG. 7, when the virtual display moving unit 227 moves the virtual display 10 (S407), the arrangement of the target object 15 in the virtual space is specified. Then, the virtual display moving unit 227 moves the virtual display 10 to a predetermined position in a direction toward the target object from the reference line of sight at the point of view. As a result, unlike the field-of-view image c₁ of part (c) of FIG. 6, the field-of-view image c₂ of part (c) of FIG. 7 is displayed such that the virtual display image is superimposed at the lower left.

In addition to the effect of the above-mentioned at least one embodiment in FIG. 6, the at least one embodiment in FIG. 7 has an effect that the virtual display 10 is applicable so as to guide the user's line of sight toward the target object 15. As the content to be displayed on the virtual display, a content associated with the attribute tag information of the target object may be displayed to enhance the line-of-sight guiding effect. For example, when the virtual display is a virtual web browser, a web page specified by the attribute tag information may be displayed. In the at least one example of FIG. 7, the virtual display is moved on a sphere concentric with the celestial sphere, but this disclosure is not limited thereto. Any mode is applicable as long as the line of sight can be guided toward the target object. As an alternative example, the virtual display may move the shortest distance toward the target object. The virtual display may be formed such that the virtual display continuously moves at an arbitrary speed toward the target object. Further, as the virtual display approaches the target object, the volume of the audio content played on the virtual display may be increased to further enhance the line-of-sight guiding effect.

The above-mentioned embodiments are merely examples for facilitating an understanding of this disclosure, and do not serve to limit an interpretation of this disclosure. One of ordinary skill in the art would understand that this disclosure can be changed and modified without departing from the gist of this disclosure, and that this disclosure includes equivalents thereof.

What is claimed is:

1. A method of providing a virtual reality space to which a user is immersed with use of a head-mounted display, the method comprising:
defining the virtual reality space;
specifying a reference line of sight from a point of view in the virtual reality space based on movement of the head-mounted display;
specifying a field-of-view region from the point of view based on the reference line of sight;
moving a virtual display in the virtual reality space to a position in the field-of-view region; and
generating a field-of-view image corresponding to the field-of-view region to display the field-of-view image on the head-mounted display.

2. The method according to claim 1, wherein the moving of the virtual display is repeatedly performed in synchronization with displacement of the reference line of sight along with the movement of the head-mounted display.

3. The method according to claim 1, further comprising determining whether a superimposition ratio of the virtual display to the field-of-view region is equal to or less than a predetermined value,
wherein the moving of the virtual display is performed in response to a determination that the superimposition ratio is equal to or less than the predetermined value.

4. The method according to claim 1, wherein the moving of the virtual display comprises moving the virtual display along a spherical surface having a first radius.

5. The method according to claim 2, wherein the moving of the virtual display comprises moving the virtual display along a spherical surface having a first radius.

6. The method according to claim 3, wherein the moving of the virtual display comprises moving the virtual display along a spherical surface having a first radius.

7. The method according to claim 4, wherein the defining of the virtual reality space comprises defining the virtual reality space such that a 360-degree content is displayed on the spherical surface having the first radius.

8. The method according to claim 4, wherein the defining of the virtual reality space comprises defining the virtual reality space such that a 360-degree content is displayed on the spherical surface having a second radius different from the first radius.

9. The method according to claim 1, wherein, in the moving of the virtual display, the position in the field-of-view region comprises a position having a predetermined polar angle or a predetermined azimuth from the reference line of sight.

10. The method according to claim 2, wherein, in the moving of the virtual display, the position in the field-of-view region comprises a position having a predetermined polar angle or a predetermined azimuth from the reference line of sight.

11. The method according to claim 3, wherein, in the moving of the virtual display, the position in the field-of-view region comprises a position having a predetermined polar angle or a predetermined azimuth from the reference line of sight.

12. The method according to claim 1,
wherein the defining of the virtual reality space comprises defining the virtual reality space such that a target object is arranged within the virtual reality space,
wherein the moving of the virtual display further comprises specifying the target object in the virtual reality space, and
wherein the virtual display is further moved to a position in the field-of-view region in a direction toward the target object from the reference line of sight at the point of view.

13. The method according to claim 2,
wherein the defining of the virtual reality space comprises defining the virtual reality space such that a target object is arranged within the virtual reality space,
wherein the moving of the virtual display further comprises specifying the target object in the virtual reality space, and
wherein the virtual display is further moved to a position in the field-of-view region in a direction toward the target object from the reference line of sight at the point of view.

14. The method according to claim 3,
wherein the defining of the virtual reality space comprises defining the virtual reality space such that a target object is arranged within the virtual reality space,
wherein the moving of the virtual display further comprises specifying the target object in the virtual reality space, and
wherein the virtual display is further moved to a position in the field-of-view region in a direction toward the target object from the reference line of sight at the point of view.

15. The method according to claim 1, wherein the moving of the virtual display is performed in response to a predetermined user action.

16. The method according to claim 2, wherein the moving of the virtual display is performed in response to a predetermined user action.

17. The method according to claim 3, wherein the moving of the virtual display is performed in response to a predetermined user action.

18. A system for providing a virtual reality space to which a user is immersed with use of a head-mounted display, the system comprising:
a computer coupled to the head-mounted display;
a space defining unit for defining the virtual reality space;
a reference line of sight specifying unit for specifying a reference line of sight based on a point of view in the virtual reality space based on movement of the head-mounted display;
a field of view region determining unit for specifying a field-of-view region based on the point of view based on the reference line of sight;
a virtual display moving unit for moving a virtual display in the virtual reality space to a position in the field-of-view region; and
a field of view image generating unit for generating a field-of-view image corresponding to the field-of-view region to display the field-of-view image on the head-mounted display.

19. The system according to claim 18, wherein the virtual display moving unit is configured to move the virtual display in synchronization with displacement of the reference line of sight along with the movement of the head-mounted display.

20. The system according to claim 18, wherein the computer is configured to determine whether a superimposition ratio of the virtual display to the field-of-view region is equal to or less than a predetermined value,
wherein virtual display moving unit is configured to move the virtual display in response to a determination that the superimposition ratio is less than or equal to the predetermined value.
